(19) United States
(12) Patent Application Publication
(10) Pub. No.: US 2010/0128463 A1
(43) Pub. Date: May 27, 2010

(54) HEADLIGHT FOR VEHICLE

(76) Inventors: Hyung Kun KIM, Gyunggi-do (KR); Young Jin LEE, Seoul (KR)

Correspondence Address: MCDERMOTT WILL & EMERY LLP, 600 13TH STREET, N.W., WASHINGTON, DC, 20005-3096, US

(21) Appl. No.: 12/626,813

(22) Filed: Nov. 27, 2009

(30) Foreign Application Priority Data
Nov. 27, 2008 (KR) 10-2008-0119184
Oct. 15, 2009 (KR) 10-2009-0098196

(51) Int. Cl. F21V 9/16

(52) U.S. Cl. 362/84; 362/539; 362/547

(57) ABSTRACT

There is provided a headlight for a vehicle. The headlight uses a light emitting device as a light source, so that light intensity can be enhanced and rectangular beams without discontinuity can be emitted, thereby enhancing light distribution characteristic.

### CROSS-REFERENCE TO RELATED APPLICATIONS

This application claims the priorities of Korean Patent Application No. 10-2008-0119184 filed on Nov. 27, 2008 and No. 10-2009-0098196 filed on Oct. 15, 2009, in the Korean Intellectual Property Office, the disclosure of which is incorporated herein by reference.

### BACKGROUND OF THE INVENTION

1. Field of the Invention

The present invention relates to a headlight, and more particularly, to a headlight for a vehicle, which includes a light emitting device package as a light source.

2. Description of the Related Art

In general, light sources employing socket bulbs are used as light sources for headlights mounted on vehicles. These socket bulbs are lighting apparatuses that produce light by filling vacuum glass bulbs with incombustible gasses and electrically heating filaments formed of tungsten or the like.

Related art socket bulbs have limitations of short useful life spans and low impact resistance, leading to frequent replacement. Accordingly, many studies have been conducted to develop bulbs that operate at low voltages and have high durability and power saving effects, such as light emitting devices (LED) or neon lamps.

Recently, packages employing light emitting devices, of which small-sized examples were used as light sources for mobile devices at their initial stage of development, have been developed to have larger sizes as they are used for large TVs, billboards, lighting apparatuses, and the headlights of vehicles.

Headlights for vehicles, employing light emitting devices, are advantageous in that high brightness levels can be achieved due to the successive arrangement of a plurality of light emitting device chips. However, these headlights may be defective in terms of light distribution as they fail to emit beams in rectangular form without discontinuities.

This discontinuity of light results from the structural limitations of intervals between light emitting device chips.

### SUMMARY OF THE INVENTION

An aspect of the present invention provides a headlight for a vehicle, which utilizes a light emitting device and a light emitting device package including the light emitting device as a light source, such that light intensity can be enhanced and superior light distribution can be ensured to thereby allow rectangular beams without discontinuity to be obtained.

According to an aspect of the present invention, there is provided a headlight for a vehicle, including: a light emitting device package including one or more light emitting device chips, a substrate on which the light emitting device chips are mounted, the substrate including one or more connection pads electrically connected to the light emitting device chips, and a resin layer including phosphors and covering and sealing the light emitting device chips and the connection pads; a heat dissipation part provided under the light emitting device package and dissipating heat generated from the light emitting device package to the outside; a reflector provided above the light emitting device package and the heat dissipation part, and inducing and reflecting light emitted from the light emitting device package; and a lens cover diffusing light reflected by the reflector to the outside.

The substrate may include a cavity formed in an upper portion thereof, receiving the light emitting device chips therein, and having a reflective surface along an inner circumferential direction inclined downward toward the light emitting device chips, the cavity being filled with the resin layer.

The resin layer may be molded on a top surface of the substrate, and integrally seal the light emitting device chips and the connection pads.

The resin layer may seal top surfaces and side surfaces of the light emitting device chips, and intervals between the light emitting device chips.

The heat dissipation part may include: a head sink on which the light emitting device package is mounted, the heat sink dissipating heat generated from the light emitting device package to the outside; and a cooling fan mounted under the heat sink and increasing heat dissipation efficiency.

The headlight may further include a housing having a central hole in which the heat dissipation part is mounted, and a front hole fixing the reflector such that the reflector is placed above the light emitting device package.

The lens cover may include: a hollow guide mounted along the front hole of the housing and guiding light reflected by the reflector in a forward direction; and a lens mounted at the front of the guide.

According to another aspect of the present invention, there is provided a headlight for a vehicle, the headlight including: a light emitting device package including one or more light emitting device chips, a substrate on which the light emitting device chips are mounted, the substrate including one or more connection pads electrically connected to the light emitting device chips, a resin layer covering and sealing the light emitting device chips and the connection pads, and a phosphor layer disposed on the resin layer and converting a wavelength of light emitted from the light emitting device chips; a heat dissipation part provided under the light emitting device package and dissipating heat generated from the light emitting device package to the outside; a reflector provided above the light emitting device package and the heat dissipation part, and inducing and reflecting light emitted from the light emitting device package; and a lens cover diffusing light reflected by the reflector to the outside.

The phosphor layer may be applied on an outer side of the resin layer.

The phosphor layer may be provided by stacking one or more phosphorous layers on an outer side of the resin layer.

The phosphorous layers being stacked may include the same phosphors or may each include a different phosphor.

The phosphorous layers may be stacked sequentially according to wavelengths thereof such that a phosphorous layer having a shorter wavelength is placed so as to be in an upper position and a phosphorous layer having a longer wavelength is placed so as to be in a lower position.

The resin layer may integrally seal top surfaces and side surfaces of the light emitting device chips, intervals between the light emitting device chips, and the connection terminals.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic view showing a headlight mounted on a vehicle, according to an exemplary embodiment of the present invention;

FIG. 2 is an exploded perspective view of the headlight depicted in FIG. 1;

FIG. 3 is a cross-sectional view illustrating the headlight depicted in FIG. 2;

FIG. 4A is a plan view illustrating a light emitting device package of a headlight for a vehicle, according to an exemplary embodiment of the present invention;

FIG. 4B is a cross-sectional view illustrating the light emitting device package depicted in FIG. 4A;

FIGS. 4C and 4D are plan views illustrating modifications of the mounting state of a light emitting device chip in the light emitting device package of FIG. 4A;

FIG. 5A is a plan view illustrating a light emitting device package in a headlight for a vehicle, according to another exemplary embodiment of the present invention;

FIG. 5B is a cross-sectional view illustrating the light emitting device package depicted in FIG. 5A; and

FIGS. 5C and 5D are plan views illustrating modifications of the mounting state of a light emitting device chip in the light emitting device package of FIG. 5A;

FIG. 6A is a plan view illustrating another embodiment of the light emitting device package depicted in FIG. 4A;

FIG. 6B is a cross-sectional view illustrating the light emitting device package of FIG. 6A;

FIG. 6C is a cross-sectional view illustrating a modification of FIG. 6B;

FIG. 7A is a plan view illustrating another embodiment of the light emitting device package depicted in FIG. 5A;

FIG. 7B is a cross-sectional view illustrating the light emitting device package of FIG. 7A; and

FIG. 7C is a cross-sectional view illustrating a modification of FIG. 7B.

### DETAILED DESCRIPTION OF THE PREFERRED EMBODIMENT

Exemplary embodiments of the present invention will now be described in detail with reference to the accompanying drawings. Like reference numerals in the drawings may denote like elements, and thus their description will be omitted.

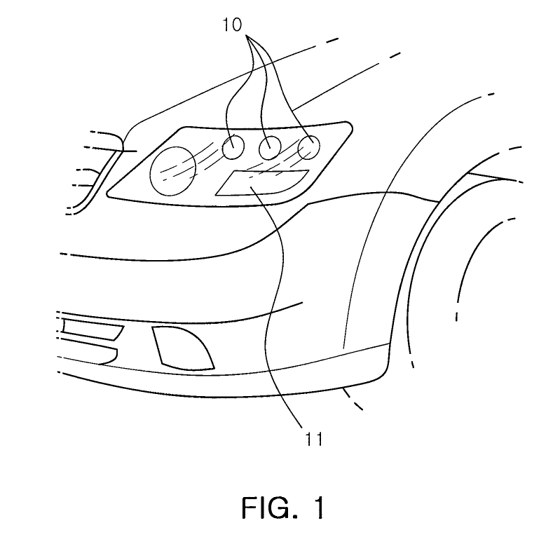

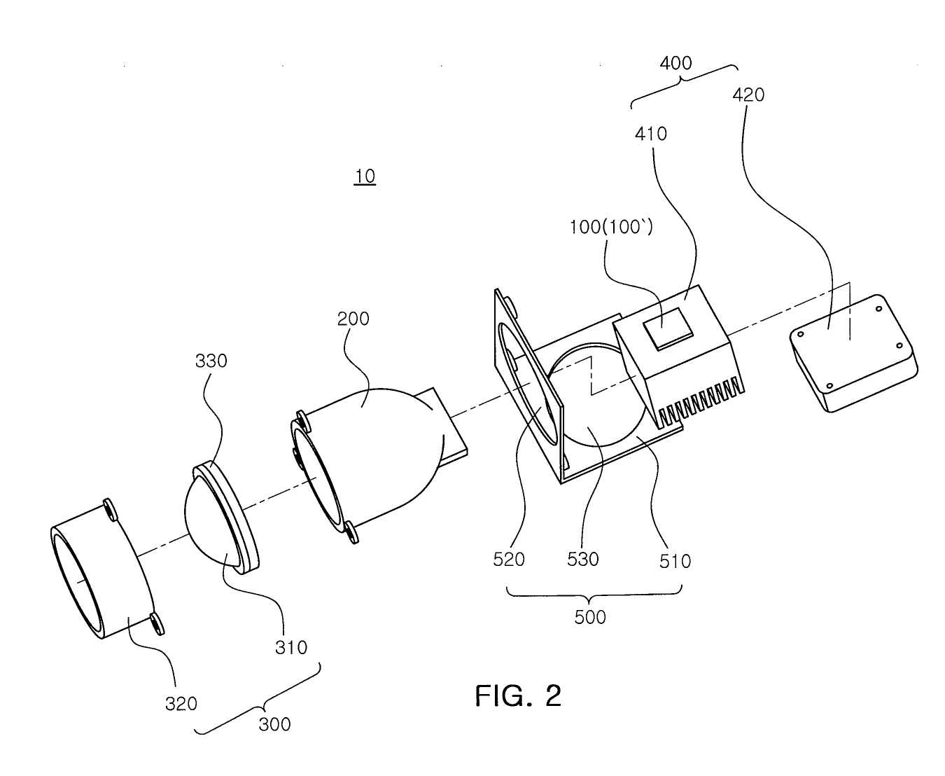

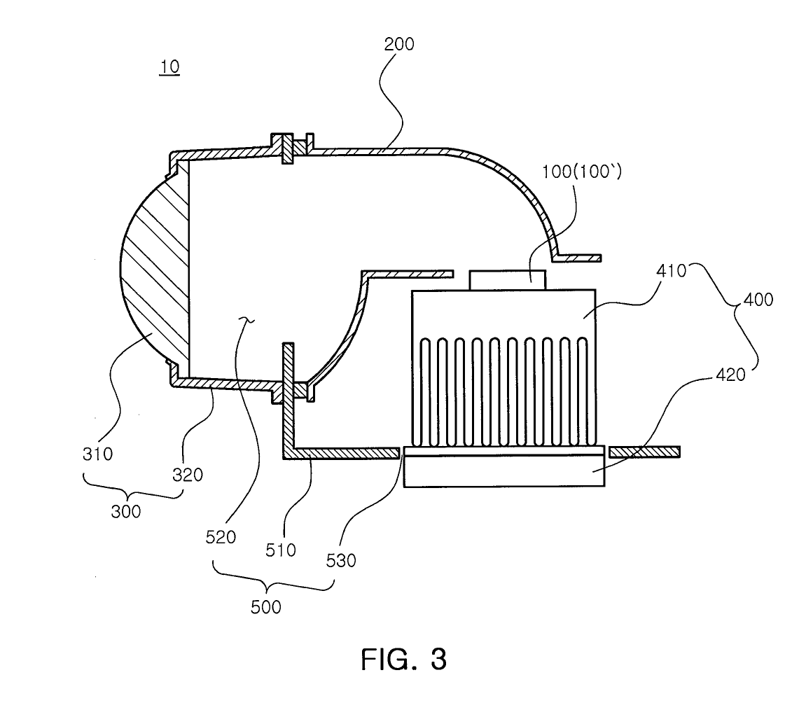

FIG. 1 is a schematic view of a headlight mounted on a vehicle, according to an exemplary embodiment of the present invention, FIG. 2 is an exploded perspective view illustrating the headlight depicted in FIG. 1, and FIG. 3 is a cross-sectional view illustrating the headlight of FIG. 2.

As shown in FIGS. 1 and 2, a headlight 10 for a vehicle, according to an exemplary embodiment of the present invention, includes a light emitting device package 100, a reflector 200, a lens cover 300 and a heat dissipation part 400.

As shown in FIG. 1, a plurality of headlights 10 may be mounted on a car. A reflective mirror 11 is formed adjacent to the headlights 10 so as to direct light, emitted from the headlight, to the front, left and right sides.

The light emitting device package 100 is mounted on the heat dissipation part 400, and is electrically connected to an external power source (not shown) to serve as a light source that emits light when receiving power.

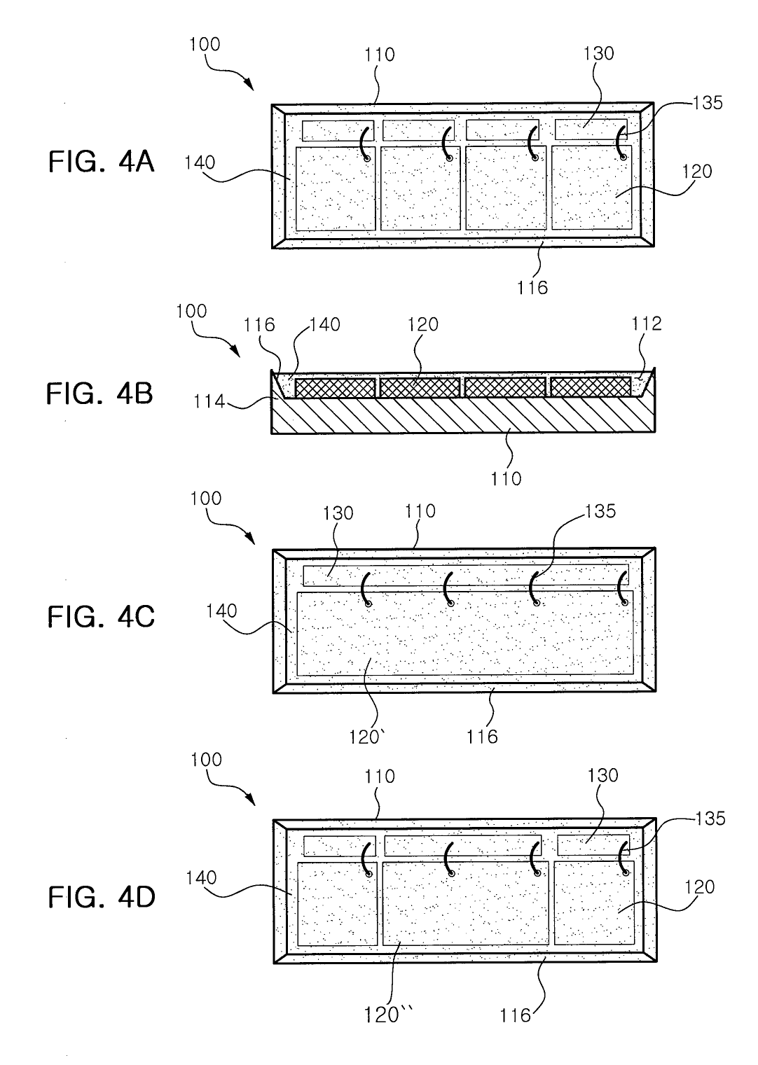

Various embodiments of the light emitting device package 100 will now be described with reference to FIGS. 4A through 7C.

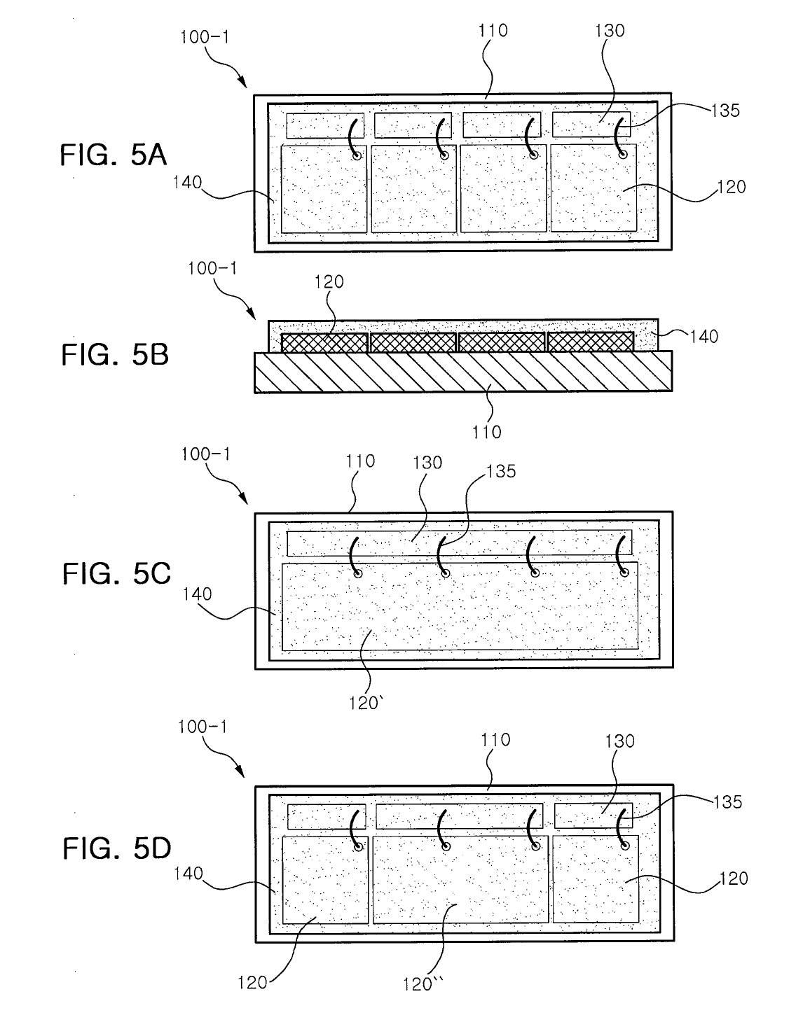

First, referring to FIGS. 4A through 5D, a light emitting device package including a resin layer containing phosphors will now be described.

FIG. 4A is a plan view of a light emitting device package for a headlight for a vehicle, according to an exemplary embodiment of the present invention. FIG. 4B is a cross-sectional view illustrating the light emitting device package depicted in FIG. 4A. FIGS. 4C and 4D are plan views illustrating modifications of the mounting state of a light emitting device chip in the light emitting device package of FIG. 4A.

FIG. 5A is a plan view of a light emitting device package of a headlight for a vehicle, according to another exemplary embodiment of the present invention. FIG. 5B is a cross-sectional view illustrating the light emitting device package depicted in FIG. 5A. FIGS. 5C and 5D are plan views illustrating modifications of the mounting state of a light emitting device chip in the light emitting device package of FIG. 5A.

With reference to FIGS. 4A through 5D, the light emitting device packages 100 and 100-1 of the embodiments each include at least one light emitting device chip 120, a substrate 110 on which the light emitting device chip 120 are mounted and including at least one connection terminal 130 electrically connected with the light emitting device chip 120, and a resin layer 140 containing phosphors and covering and sealing the light emitting device chips 120 and the connection pads 130.

Each light emitting device chip 120 is a type of semiconductor device that is mounted on the top of the substrate 110 and emits light having a predetermined wavelength when receiving external power. As shown in FIGS. 4A and 4B and 5A and 5B, a plurality of light emitting device chips 120 may be provided on the central portion of the substrate 110.

In this case, the light emitting device chips 120 may be arrayed as a combination of blue, red and green light emitting devices, thereby emitting white light.

However, the present invention is not limited to the above description. As shown in FIGS. 4C and 5C, a single light emitting device chip 120′ may be provided on the central portion of the substrate 110. In this case, the light emitting device chip 120′ may be a blue light emitting device or a UV light emitting device, and emits white light due to phosphors contained in the resin layer 140 to be described later.

Furthermore, as shown in FIGS. 4D and 5D, a longer light emitting device chip 120″ may be provided on the central portion of the substrate 110, and shorter light emitting device chips 120 may be provided on both sides of the longer light emitting device chip 120″, thereby realizing a symmetrical structure of the light emitting device chips 120″ and 120.

In this case, the light emitting device chip 120″ on the central portion may be 1.5 or 2 times longer than either one of the light emitting device chips 120 on both sides thereof. The longer light emitting device chip 120″ may be a green light emitting device, but is not limited thereto.

The light emitting device chip 120 is electrically connected to the connection terminal 130, patterned on the top surface of the substrate 110, via a metal wire 135.

As shown in FIGS. 4A and 4B illustrating the light emitting device package 100 according to an exemplary embodiment of this invention, the substrate 110 has a cavity 112 in its upper portion. The light emitting device chip 120 and the connection terminal 130 are mounted inside the cavity 112, and the cavity 112 also has a reflective surface along an inner circumferential surface sloped downward toward the light emitting device chip 120 and the connection terminal 130 therein.

The cavity 112 may be formed as a recess in the top of the substrate 110 by using a laser or an etching process. Alternatively, a resin 140 may be molded to a predetermined height along the top edge of the substrate 110, so that the reflective surface 116 protrudes.

For the efficient realization of the reflective surface 116, a reflective layer having high reflectivity may be further provided on the reflective surface 116.

The cavity 112 is filled with the resin layer 140 containing phosphors. Here, the resin layer 140 integrally covers and seals the top surface of the substrate 110, the light emitting device chips 120, the metal wires 135 and the connection pads 130, thereby protecting the light emitting device chips 120 and the like arranged inside the cavity 112.

In the light emitting device package 100, the resin layer 140 seals the top surfaces and the side surfaces of the light emitting device chips 120, including the interval between the light emitting device chips 120.

Thus, the above embodiments of this invention can solve the limitation that light is seen as discontinuous light, typically caused due to intervals between light emitting device chips in the related art light emitting device packages where phosphors are applied only on the tops of the light emitting device chips 120.

As shown in FIGS. 5A and 5B, the light emitting device package 100-1 according to this embodiment has the resin layer 140 molded with a predetermined size and height on the flat top surface of the substrate 110, thus integrally covering and sealing the light emitting device chips 120 and the connection pads 130.

As in the previous embodiment, the resin layer 140 in the light emitting device package 100′, according to this embodiment, seals the top surfaces and the side surfaces of the light emitting device chips 120, including the intervals between the light emitting device chips 120.

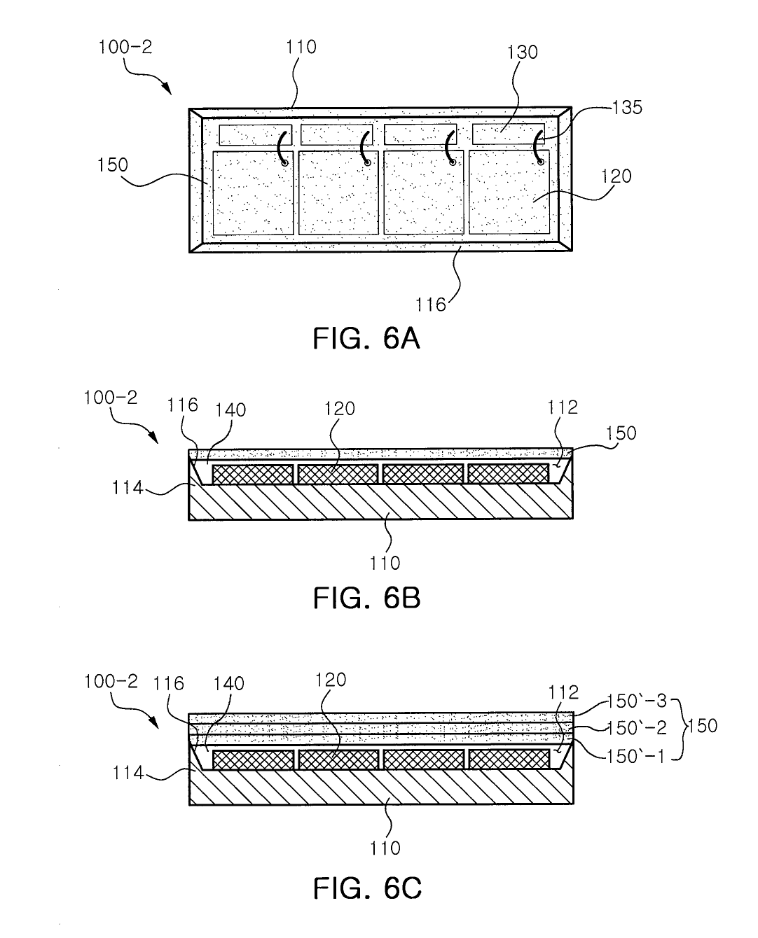

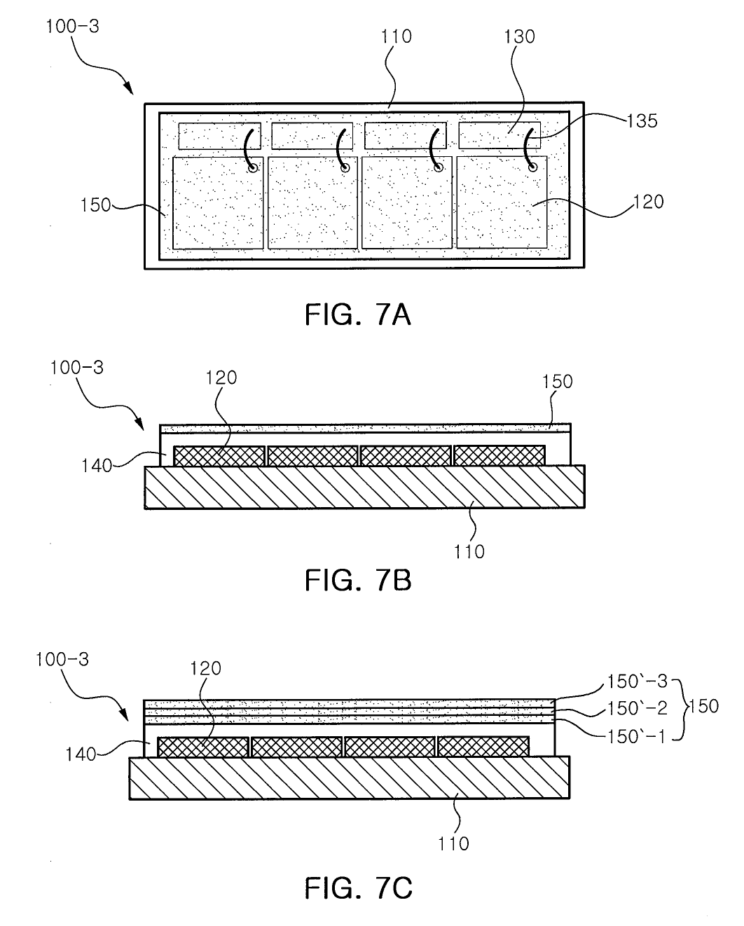

Referring to FIGS. 6 and 7, there will be described a light emitting device package including a phosphor layer placed on a resin layer and containing phosphors to convert the wavelength of light emitted from the light emitting device chip.

FIG. 6A is a plan view illustrating another embodiment of the light emitting device package depicted in FIG. 4A. FIG. 6B is a cross-sectional view illustrating the light emitting device package of FIG. 6A. FIG. 6C is a cross-sectional view illustrating a modification of FIG. 6B.

A light emitting device package 100-2 depicted in FIG. 6 has substantially the same structure as in the embodiment of FIGS. 4A through 4D, except that a phosphor layer containing phosphors is placed on the resin layer in the light emitting device package 100-2. Therefore, descriptions of the same elements as in the embodiment of FIG. 4A will be omitted, and only differences will now be described.

As shown in FIGS. 6A through 6C, the resin layer 140 is filled in the cavity 112, and integrally covers and seals the light emitting device chips 120, the metal wires 135, the connection terminals 130 and the top surface of the substrate 110. Here, the resin layer 140, according to this embodiment, does not contain phosphors.

The resin layer 140, as in the previous embodiment of FIG. 4A, seals the intervals between the light emitting device chips 120, and the top surfaces and the side surfaces of the light emitting device chips 120, as well as the connection terminals 130.

A phosphor layer 150 is provided on the resin layer 140, and contains phosphors converting the wavelength of light emitted from the light emitting device chips 120.

The phosphor layer 150 is provided on the resin layer 140. Here, the phosphor layer 150 may be provided by applying a phosphor material onto the outer side of the resin layer 140. Alternatively, the phosphor layer 150 may be provided by attaching a phosphorous layer onto the outer side of the resin layer 140. In this case, the phosphor layer 150 may have a multilayer structure obtained by stacking one or more phosphorous layers.

As shown in FIG. 6B, phosphors are distributed in the phosphor layer 150 in order to convert the wavelength of light. The phosphors may be a mixture of at least one of blue, green, red and yellow phosphors.

As shown in FIG. 6C, if the phosphor layer 150 has a multilayer structure, the phosphorous layers of the phosphor layer 150 may contain the same kind of phosphors or may each contain a different kind of phosphors. Although, a stack of three layers is illustrated in the drawing, the present invention is not limited to the embodiment of the illustration.

The layers of the phosphor layer 150 may be stacked such that a phosphor layer having a shorter wavelength is placed in an upper position and a phosphor layer having a longer wavelength is placed in a lower position. That is, the layers of the phosphor layer 150 may be stacked sequentially according to their wavelengths.

For example, if the light emitting device chip 120 is a UV light emitting device chip, a first phosphor layer 150′-1 on the light emitting device chip 120 may be formed of a mixture of phosphors emitting red light (R) and a resin material. The phosphors emitting red light (R) may utilize a phosphor material excited by UV rays to emit light having a wavelength ranging from 580 nm to 700 nm, preferably from 600 nm to 650 nm.

A second phosphor layer 150′-2 is stacked on the first phosphor 150′-1 and may be formed of a mixture of phosphors emitting green light (G) and a resin material. The phosphors emitting green light G may utilize a phosphor material excited by UV rays to emit light having a wavelength ranging from 500 nm to 550 nm.

A third phosphor layer 150′-3 is stacked on the second phosphor layer 150′-2, and may be formed of a mixture of phosphors emitting blue light (B) and a resin material. The phosphors emitting blue light may utilize a phosphor material excited by UV rays and emitting light having a wavelength ranging from 420 nm to 480 nm.

The UV rays emitted from a UV light emitting device chip excite different kinds of phosphors contained in the first phosphor layer 150′-1, the second phosphor layer 150′-2 and the third phosphor layer 150′-3. Accordingly, red light (R), green light (G) and blue light (B) are emitted from the first, second and third phosphor layers 150′-1, 150′-2 and 150′-3, and these three colors of light are combined to thereby produce white light (W).

That is, the phosphor layer converting UV rays using phosphors are formed into a multilayer structure, namely, a triple layer structure. Notably, the first phosphor layer 150′-1 emitting red light (R) is stacked first on the UV light emitting device chip 120, and the second phosphor layer 150′-2 and the third phosphor layer 150′-3, emitting light having shorter wavelengths, namely, green light (G) and blue light (B) respectively, are sequentially stacked on the first phosphor layer 150′-1.

Since the first phosphor layer 150′-1 containing phosphors emitting red light (R) having the lowest light conversion efficiency is placed immediately adjacent to the UV light emitting device chip 120, the light conversion efficiency of the first phosphor layer 150′-1 can be relatively increased, and the overall light conversion efficiency of the light emitting device chip can be enhanced accordingly.

When the light emitting device chip 120 emits blue light (B) having a wavelength ranging from 420 nm to 480 nm as excitation light, the first phosphor layer 150′-1 on the light emitting device chip 120 is formed of a mixture of phosphors emitting red light (R) and a resin material, and the second phosphor layer 150′-2 and the third phosphor layer 150′-3 sequentially stacked on the first phosphor layer 150′-1 are formed of mixtures of phosphors emitting green light (G) or yellow light (Y) and a resin material.

Therefore, blue light (B) emitted from the light emitting device chip 120 excites the phosphors contained in the first phosphor layer 150′-1 to emit red light (R), and excites the phosphors contained in the second phosphor layer 150′-2 and the third phosphor layer 150′-3 to emit green light (G) or yellow light (Y). The red light (R) and the green light (G) or the yellow light (Y) emitted from the multilayer phosphor layer 150 are combined with the blue light (B) emitted from the light emitting device chip 120, thereby producing white light (W).

FIG. 7A is a plan view illustrating another embodiment of the light emitting device package depicted in FIG. 5A. FIG. 7B is a cross-sectional view illustrating the light emitting device package of FIG. 7A. FIG. 7C is a cross-sectional view illustrating a modification of FIG. 7B.

In FIGS. 7A through 7C, a light emitting device package 100-3 has substantially the same construction as in the embodiment of FIG. 5A, except that a phosphor layer containing phosphors is provided at the outer side of the resin layer. Description of the same elements as in the embodiment of FIG. 5A will be omitted, and only differences will now be described.

As shown in FIGS. 7A through 7C, the resin layer 140 is provided on the flat top surface of the substrate 110, and integrally covers and seals the light emitting device chip 120, the metal wires 130, the connection terminals 130 and the top surface of the substrate 110. Here, the resin layer 140 does not contain phosphors.

This embodiment is identical to the previous embodiment of FIG. 6A in that it does not contain phosphors and the phosphors are contained in the phosphor layer 150 provided on the resin layer 140.

As shown in FIG. 7B, the phosphors contained in the phosphor layer 150 may be a mixture of at least one of blue, green and yellow phosphors.

In the case of a multilayer phosphor layer as shown in FIG. 7C, the phosphorous layers of the phosphor layer 150 may contain the same kind of phosphors or may each contain a different kind of phosphors. Although a stack of three layers is illustrated in the drawing, the present invention is not limited thereto.

The layers of the phosphor layer 150 may be stacked such that a phosphor layer with a shorter wavelength is placed in an upper position and a phosphor layer with a longer wavelength is placed in a lower position. That is, the layers of the phosphor layer 150 may be stacked sequentially according to their wavelengths.

The concrete structure of the phosphor layer 150 is substantially the same as the phosphor layers 150 depicted in FIGS. 6B and 6C. Therefore, a detailed description thereof will be omitted.

Referring back to FIGS. 2 and 3, the heat dissipation part 400 includes a heat sink 410 and a cooling fan 420. The light emitting device package 100 is provided on the heat dissipation part 400, so that heat from the light emitting device package 100 is dissipated to the outside.

In detail, the light emitting device package 100 is mounted on the top surface of the heat sink 410. The heat sink 410 dissipates high temperature heat generated from the light emitting device package 100. The heat sink 410 may include a plurality of recesses in its bottom so as to increase a surface area.

The cooling fan 420 is mounted under the heat sink 410 so that the heat dissipation efficiency of the heat sink 410 can be increased.

The reflector 200 is provided above the light emitting device package 100 and the heat dissipation part 400, and induces and reflects light emitted from the light emitting device package 100.

As shown in FIGS. 2 and 3, the reflector 200 has a dome-shaped cross-section so that the reflector 200 guides light, emitted from the light emitting device chips 120, in a forward direction of a vehicle. Also, the reflector 200 has an open front to direct the reflected light to the outside.

The headlight 10 for a vehicle, according to the exemplary embodiment of the present invention, further includes a housing 500 that fixes and supports the heat dissipation part 400 and the reflector 200.

In detail, the housing 500 includes a central hole 530 in its one side, and a front hole 520 in its other side integrally connected to the one side in a perpendicular manner. The heat dissipation part 400 is coupled and mounted to the central hole 530. The front hole 520 fixes the reflector 200 so as to be placed above the light emitting device package 100.

Thus, the reflector 200 is fixed to the housing 500 such that the open front of the reflector 200 corresponds to the front hole 520. Accordingly, light reflected by the reflector 200 passes through the front hole 520 and is then emitted to the outside.

The lens cover 300 includes a hollow guide 320 and a lens 310, and radiates light, reflected by the reflector 200, to the outside.

In detail, the guide 320 is mounted along the front hole 520 of the housing 500, and guides light, reflected by the reflector 200 and passing through the front hole 520, to the front.

The guide 320 has a hollow cylindrical structure to receive the lens 310 therein, and is a plastic molded structure formed by injection molding.

The lens 310 is mounted at the front of the guide 320, and refracts and disperses light forwardly of a vehicle. The lens 310 may be formed of a transparent material.

As described above, the headlight for a vehicle according to the embodiments of the present invention includes a light emitting device package as a light source that emits light. In the light emitting device package, a resin layer containing phosphors integrally seals light emitting device chips and connection terminals electrically connected to the light emitting device chips. Alternatively, a phosphor layer containing phosphors is provided on the outer side of a resin layer. Accordingly, despite intervals between successively disposed light emitting device chips, continuous light can be emitted without discontinuity, so that superior light distribution characteristics can be achieved.

As set forth above, according to exemplary embodiments of the invention, the headlight for a vehicle according to the exemplary embodiments of the present invention uses a light emitting device as a light source, so that a long life span and enhanced light efficiency and intensity can be achieved, and rectangular beams without discontinuity can be emitted, thereby enhancing light distribution characteristics.

While the present invention has been shown and described in connection with the exemplary embodiments, it will be apparent to those skilled in the art that modifications and variations can be made without departing from the spirit and scope of the invention as defined by the appended claims.

What is claimed is:

1. A headlight for a vehicle, the headlight comprising:
a light emitting device package including one or more light emitting device chips, a substrate on which the light emitting device chips are mounted, the substrate including one or more connection pads electrically connected to the light emitting device chips, and a resin layer including phosphors and covering and sealing the light emitting device chips and the connection pads;
a heat dissipation part provided under the light emitting device package and dissipating heat generated from the light emitting device package to the outside;
a reflector provided above the light emitting device package and the heat dissipation part, and inducing and reflecting light emitted from the light emitting device package; and
a lens cover diffusing light reflected by the reflector to the outside.

2. The headlight of claim 1, wherein the substrate includes a cavity formed in an upper portion thereof, receiving the light emitting device chips therein, and having a reflective surface along an inner circumferential direction inclined downward toward the light emitting device chips, the cavity being filled with the resin layer.

3. The headlight of claim 1, wherein the resin layer is molded on a top surface of the substrate, and integrally seals the light emitting device chips and the connection pads.

4. The headlight of claim 1, wherein the resin layer seals top surfaces and side surfaces of the light emitting device chips, and intervals between the light emitting device chips.

5. The headlight of claim 1, wherein the heat dissipation part comprises:
a head sink on which the light emitting device package is mounted, the heat sink dissipating heat generated from the light emitting device package to the outside; and
a cooling fan mounted under the heat sink and increasing heat dissipation efficiency.

6. The headlight of claim 1, further comprising a housing having a central hole in which the heat dissipation part is mounted, and a front hole fixing the reflector such that the reflector is placed above the light emitting device package.

7. The headlight of claim 6, wherein the lens cover comprises:
a hollow guide mounted along the front hole of the housing and guiding light reflected by the reflector in a forward direction; and
a lens mounted at the front of the guide.

8. A headlight for a vehicle, the headlight comprising:
a light emitting device package including one or more light emitting device chips, a substrate on which the light emitting device chips are mounted, the substrate including one or more connection pads electrically connected to the light emitting device chips, a resin layer covering and sealing the light emitting device chips and the connection pads, and a phosphor layer disposed on the resin layer and converting a wavelength of light emitted from the light emitting device chips;
a heat dissipation part provided under the light emitting device package and dissipating heat generated from the light emitting device package to the outside;
a reflector provided above the light emitting device package and the heat dissipation part, and inducing and reflecting light emitted from the light emitting device package; and
a lens cover diffusing light reflected by the reflector to the outside.

9. The headlight of claim 8, wherein the phosphor layer is applied on an outer side of the resin layer.

10. The headlight of claim 8, wherein the phosphor layer is provided by stacking one or more phosphorous layers on an outer side of the resin layer.

11. The headlight of claim 10, wherein the phosphorous layers being stacked include the same phosphors or each include a different phosphor.

12. The headlight of claim 10, wherein the phosphorous layers are stacked sequentially according to wavelengths thereof such that a phosphorous layer having a shorter wavelength is placed so as to be in an upper position and a phosphorous layer having a longer wavelength is placed so as to be in a lower position.

13. The headlight of claim 8, wherein the resin layer integrally seals top surfaces and side surfaces of the light emitting device chips, intervals between the light emitting device chips, and the connection terminals.
